(19) United States
(12) Patent Application Publication
(10) Pub. No.: US 2024/0236448 A1
(43) Pub. Date: Jul. 11, 2024

(54) COMPOSITE IMAGE RECOGNITION DEVICE

(71) Applicant: Chung Hua University, HsinChu (TW)

(72) Inventors: Chi-Sheng HSIEH, Hsinchu City (TW); Kung-Jeng MA, Hsinchu City (TW); Yi-Hsuan LAI, Hsinchu City (TW); Yea-Shuan HUANG, Hsinchu County (TW)

(21) Appl. No.: 18/344,839

(22) Filed: Jun. 29, 2023

(30) Foreign Application Priority Data
Jan. 6, 2023 (TW) 112100511

(51) Int. Cl. H04N 23/11; H04N 23/12; H04N 23/74; H04N 23/80

(52) U.S. Cl. CPC H04N 23/11; H04N 23/12; H04N 23/74; H04N 23/80; F41G 3/165

(57) ABSTRACT

A composite image recognition device includes a thermal-imaging device, an adjustable light source module, and a low-light level night vision device. The thermal-imaging device captures a first image of an area and a second image of the area, and the first image and the second image are fused by the image fusion processor. The adjustable light source module is located in the thermal-imaging device, and includes a near infrared light source and a light controller. The near infrared light source is electrically connected to the light controller, and the light intensity of the near infrared light source is adjusted by the light controller. The low-light level night vision device is adjacent to the thermal-imaging device, and a brightening visible light image of the area is captured by the low-light level night vision device.

### RELATED APPLICATIONS

This application claims priority to Taiwan Application Serial Number 112100511, filed, Jan. 6, 2023, which is herein incorporated by reference.

### BACKGROUND

### Field of Disclosure

The present disclosure relates to a composite image recognition device.

### Description of Related Art

The function of a common thermal-imaging device, or also named as infrared-thermography camera, is to shoot a “thermal” image when the temperature of the object is different from the temperature of the background environment. According to modern physics, all objects (above −273 degree Celsius) will irradiate and also absorb infrared light. Such thermal technology is a kind of technology that let the radiation of infrared thermal energy of the object observed by human eye. The application of thermal-imaging is very wide, which covers measurement, monitoring, medical care and military. Most of the high-level infrared thermal-imaging device for military use is controlled by U.S. government, such as the limitation of the sales of the night-vision technology/equipment of the U.S. by the Ministry of Defense, the United State Department and the Ministry of Commerce.

The night-vision equipment for military use is crucial, such as the AN/PSQ-20 used by the U.S. military. However, not only the price is expensive and hard to afford, but also the problem of “unable to clearly see the object hiding in the dark shadow” appears according to the graphical data and literature published by Defense International. Our country should independently research and develop night-vision related equipment and enhance the key component of military use to reduce the cost of purchasing overseas.

### SUMMARY

One aspect of the present disclosure provides a composite image recognition device.

According to one embodiment of the present disclosure, a composite image recognition device includes a thermal-imaging device, an adjustable light source module and a low-light level night vision device. The thermal-imaging device includes a far infrared lens, a near infrared (NIR) lens and an image fusion processor. The thermal-imaging device captures a first image of an area by a light that is allowed to pass through the far infrared lens and captures a second image of the area by a light that is allowed to pass through the near infrared lens, in which the first image is a far infrared image, and the second image includes a near infrared image and a visible light image. The image fusion processor obtains a first transition function that transfers a coordinate of the far infrared image to a coordinate of the visible light image and a second transition function that transfers a coordinate of the near infrared image to a coordinate of the visible light image respectively according to the following projective geometry: COOR(p_{B}ⁱ)=T×COOR(p_{A}ⁱ), in which T is a transition function, COOR(p_{A}ⁱ) is a coordinate of a characteristic point of any one of the far infrared image and the near infrared image, and COOR(p_{B}ⁱ) is a coordinate of a characteristic point of the visible light image. The image fusion processor fuses the far infrared image and the visible light image according to the first transition function and fuses the near infrared image and the visible light image according to the second transition function. The adjustable light source module is located in the thermal-imaging device, includes a near infrared light source and a light controller electrically connected to each other and irradiates the area through a near infrared light emitted by the near infrared light source. The low-light level night vision device is adjacent to the thermal-imaging device and captures a brightened visible light image through the low-light level night vision device.

In some embodiments of the present disclosure, the thermal-imaging device include an image sensor, the image sensor faces toward the near infrared lens, the image sensor and the near infrared lens have no infrared cut filter in between, and the thermal-imaging device captures a visible light and a near infrared light through the image sensor.

In some embodiments of the present disclosure, the thermal-imaging device has a digital circuit unit, and the digital circuit unit electrically connects the image sensor and the image fusion processor.

In some embodiments of the present disclosure, the thermal-imaging device has a digital circuit unit, the digital circuit unit electrically connects a focal plane array and the image fusion processor and transfer an infrared light received by the focal plane array to a digital data for the image fusion processor to process an image.

In some embodiments of the present disclosure, the light controller electrically connects the image fusion processor, and the image fusion processor hereby sends a brightening signal or a darkening signal to the light controller, such that the near infrared light source adjusts an intensity automatically.

In some embodiments of the present disclosure, a wavelength of the near infrared light source of the adjustable light source module is in a range of 920 nanometers to 960 nanometers, and hereby provides an invisible light to the area and improves a sharpness of the second image of the thermal-imaging device.

In some embodiments of the present disclosure, the near infrared lens of the thermal-imaging device is configured to allow passage of a light with a wavelength in a range of 0.4 micrometers to 1.0 micrometers, and hereby captures the near infrared image and the visible light image of the second image.

In some embodiments of the present disclosure, the composite image recognition device further includes a head-mounted display. The head-mounted display includes a first screen and a second screen, the first screen electrically connects the image fusion processor, the second screen electrically connects the low-light level night vision device, hereby, the first screen displays an image fused from the first image and the second image, and the second screen displays the brightened visible light image of the low-light level night vision device.

In some embodiments of the present disclosure, the composite image recognition device further includes a wireless transmission module and a wireless receiving module. The wireless transmission module electrically connects the image fusion processor. The wireless receiving module electrically connects the head-mounted display and wirelessly connects to the wireless transmission module, hereby, the image fused from the first image and the second image wirelessly transmitted to the first screen of the head-mounted display.

In some embodiments of the present disclosure, the image fusion processor shoots a far infrared light learning image, a near infrared light learning image and a visible light learning image on a template plane with N characteristic points, or intersecting straight lines or circles that is sensitive to far infrared light, near infrared light and visible light through the thermal-imaging device, the N characteristic points p_{A}¹, p_{A}² . . . , p_{A}^{N} of any one of the far infrared light learning image and near infrared light learning image correspond to the N characteristic points p_{B}¹, p_{B}² . . . , p_{B}^{N} of the visible light learning image in sequence, and thus the first transition function and the second transition function are obtained by using projective geometry COOR(p_{B}ⁱ)=T×COOR(p_{A}ⁱ), hereby, the image fusion processor fuses the first image and the second image.

One aspect of the present disclosure provides a composite image recognition device.

According to one embodiment of the present disclosure, a composite image recognition device includes a thermal-imaging device, an adjustable light source module and a low-light level night vision device. The thermal-imaging device includes a far infrared lens, a near infrared (NIR) lens, an image sensor and an image fusion processor. The thermal-imaging device captures a first image of an area by a light that is allowed to pass through the far infrared lens, and captures a second image of the area by a light that is allowed to pass through the near infrared lens, in which the first image is a far infrared image, and the second image includes a near infrared image and a visible light image. The image fusion processor obtains a first transition function that transfers a coordinate of the far infrared image to a coordinate of the visible light image and a second transition function that transfers a coordinate of the near infrared image to a coordinate of the visible light image respectively according to the following projective geometry: COOR(p_{B}ⁱ)=T×COOR(p_{A}ⁱ), in which T is a transition function, COOR(p_{A}ⁱ) is a coordinate of a characteristic point of any one of the far infrared image and the near infrared image, and COOR(p_{B}ⁱ) is a coordinate of a characteristic point of the visible light image. The image fusion processor fuses the far infrared image and the visible light image according to the first transition function, and fuses the near infrared image and the visible light image according to the second transition function. The image sensor faces toward the near infrared lens. The adjustable light source module is located in the thermal-imaging device, includes a near infrared light source and irradiates the area through a near infrared light emitted by the near infrared light source. The low-light level night vision device is adjacent to the thermal-imaging device and captures a brightened visible light image through the low-light level night vision device.

In some embodiments of the present disclosure, the thermal-imaging device further includes an infrared pass filter. The infrared pass filter is located between the near infrared lens and the image sensor, and hereby allows passage of a near infrared light and detection by the image sensor for.

In some embodiments of the present disclosure, the thermal-imaging device further includes a focal plane array, the focal plane array faces toward the far infrared lens and hereby receives an infrared light from the area.

In some embodiments of the present disclosure, the composite image recognition device further includes at least one case accommodating the thermal-imaging device and the adjustable light source module, hereby, the far infrared lens and the near infrared lens of the thermal-imaging device and the near infrared light source of the adjustable light source module are located at a front side of the case and faces toward the same direction.

In some embodiments of the present disclosure, the far infrared lens of the thermal-imaging device is configured to allow passage of a light with a wavelength in a range from 8 micrometers to 14 micrometers, and hereby captures the far infrared image of the first image.

In the aforementioned embodiments of the present disclosure, since the composite image recognition device includes a thermal-imaging device, an adjustable light source module and a low-light level night vision device, and the thermal-imaging device includes a far infrared lens, a near infrared (NIR) lens and an image fusion processor, such that when the composite image recognition device observes an area, the thermal-imaging device can capture a far infrared image (i.e. the first image) and a near infrared/visible light image (i.e. the second image) of the area. The low-light level night vision device can capture a brightened visible light image of which luminous is enhanced of the area, and the adjustable light source module can adjust the brightness of the light according to the brightness of the area. For example, if we want to see an object in the shadow of the area, the luminosity of the near infrared light source can be enhanced by the light controller; if the area is too bright and causes overexposure, the luminosity of the near infrared light source can be reduced by the light controller. As a result of such a design, the sharpness of the near infrared light image can be greatly improved. After the image fusion processor fuses the first image and the second image, a clear image of the object hiding in the shadow originally can be produced. The composite image recognition device can be applied in night vision related apparatus of measurement, monitoring, medical care and military, is beneficial to the independent research and development of key component of military use and reduce the cost of purchasing oversea.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of the composite image recognition device according to one embodiment of the present disclosure.

FIG. 2A is a schematic view of the composite image recognition device of FIG. 1 when operating.

FIG. 2B is a flow chart of image processing of the image fusion processor of FIG. 2A

FIG. 3 is a schematic view of the composite image recognition device when operating according to another embodiment of the present disclosure.

FIG. 4 is a schematic view of the composite image recognition device when operating according to yet another embodiment of the present disclosure.

FIG. 5 is a schematic view of the composite image recognition device when operating according to yet another embodiment of the present disclosure.

FIG. 6 is a side view of a military equipment according to some embodiment of the present disclosure.

FIG. 7 is a schematic view of the military equipment of FIG. 6 when using.

FIG. 8 is a schematic view of the military equipment of FIG. 6 when using.

FIG. 9 is a schematic view of the military equipment of FIG. 6 when using.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the drawings. The spatially relative terms are intended to encompass different orientations of the device in use or operation in addition to the orientation depicted in the drawings. The apparatus may be otherwise oriented (rotated 90 degrees or at other orientations) and the spatially relative descriptors used herein may likewise be interpreted accordingly.

The function of a traditional thermal-imaging device, or also named as infrared-thermography camera, is to shoot a “thermal” image when the temperature of the object is different from the temperature of the background environment. According to modern physics, all objects (above −273 degree Celsius) will irradiate and also absorb infrared light. Such thermal technology is a kind of technology that let the radiation of infrared thermal energy of the object actually observed by human eye. The difference between the thermal-imaging device in the present disclosure and the traditional thermal-imaging device is that the thermal-imaging device in the present disclosure can not only capture a far infrared image with a wavelength in a range of 8 micrometers to 14 micrometers, but also further captures a near infrared image with a wavelength in a range of 0.8 micrometers to 1 micrometer and a visible light image with a wavelength in a range of 0.4 micrometers to 0.8 micrometers. Furthermore, the low-light level night vision device in the present disclosure is amplifying the “trace” of the visible light (such as moon light of star light) to identify objects in dark night environment. Since the “far, near infrared light” wave band and the “star-light (low-light) level environment” is a range that cannot be detected by human eye, the thermal-imaging device and the low-light level night vision device are beneficial to the application of aiming system and surveillance cameras. The structural configuration, electrical connection and the operation method of the composite image recognition device includes the thermal-imaging device and the low-light level night vision device mentioned above of the present disclosure are described in the following.

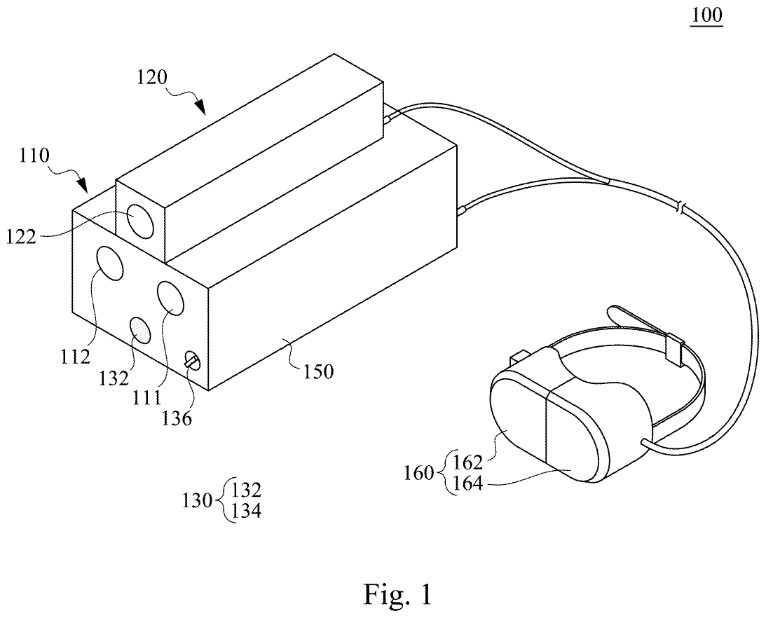

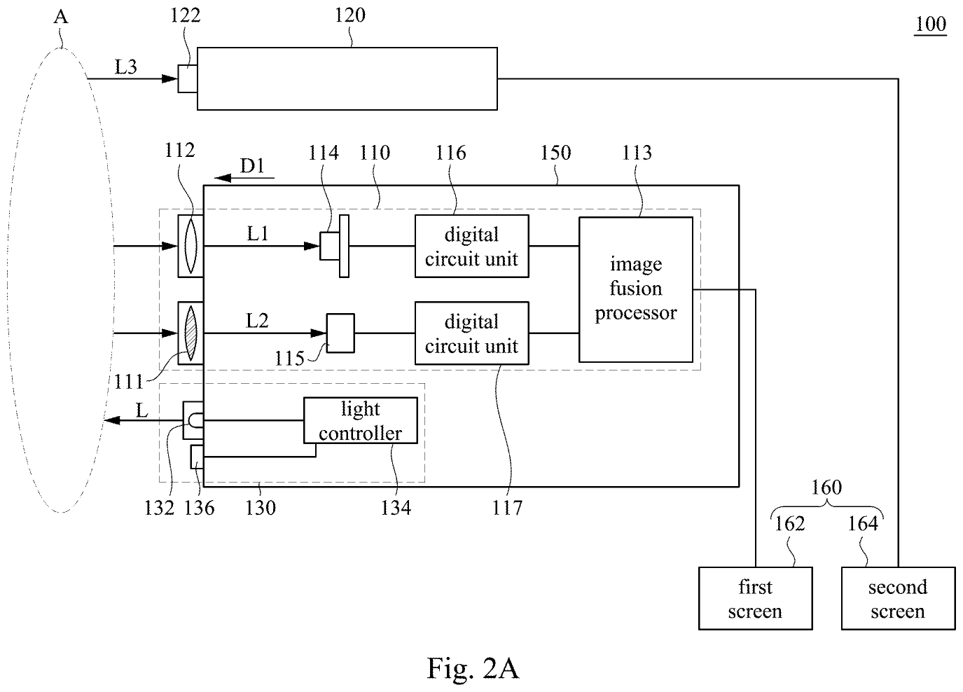

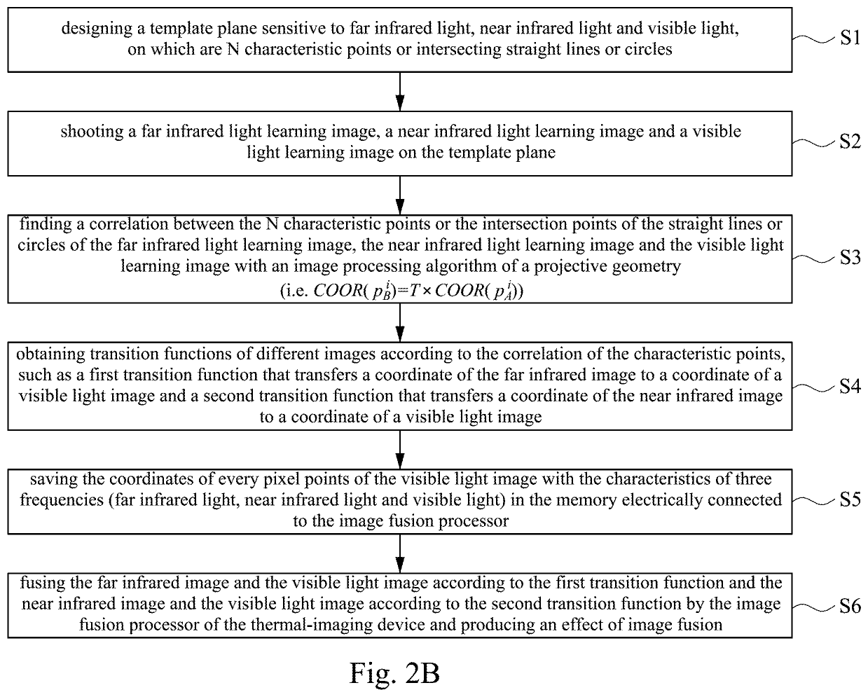

FIG. 1 is a perspective view of the composite image recognition device 100 according to one embodiment of the present disclosure. FIG. 2A is a schematic view of the composite image recognition device 100 of FIG. 1 when operating. Refer to FIG. 1 and FIG. 2A, the composite image recognition device 100 includes a thermal-imaging device 110, an adjustable light source module 120 and a low-light level night vision device 130. Furthermore, the composite image recognition device 100 also includes at least one case 150 to accommodate the thermal-imaging device 110 and the low-light level night vision device 130. The number and the shape of the case is not limited in the present disclosure. In the present embodiment, the thermal-imaging device 110 and the low-light level night vision device 130 is integrated in a single case 150.

The thermal-imaging device 110 includes a near infrared (NIR) lens 111, a far infrared lens 112 and an image fusion processor 113. When the composite image recognition device 100 is used to observe a target in the area A, the thermal-imaging device 110 can captures a first image through the passage of the light L1 allowed by the far infrared lens 112, in which the first image is a far infrared thermal image. When the composite image recognition device 100 is used to observe a target in the area A, the thermal-imaging device 110 can captures a second image through the passage of the light L2 allowed by the near infrared lens 111, in which the second image includes a near infrared image and a visible light image. Furthermore, the image fusion processor 113 is configured to fuse the first image and the second image. The method of fusing the first image and the second image of the thermal-imaging device 110 is described in the following, in which the first image is a far infrared image obtained by detecting the far infrared light, the second image includes a near infrared image obtained by detecting the near infrared light and a visible light image obtained by detecting the visible light.

After the image fusion processor 113 obtains transition functions between different types (wavelength ranges) of image through an image processing algorithm, they can be applied in the transferring calculation between different types (wavelength ranges) of image, the details are described in the following. First, designing a template plane. The template plane uses composite material that is sensitive to far infrared light, near infrared light and visible light, and prints several (such as N) characteristic points or intersecting straight lines or circles. Thereafter, shooting, by the composite image recognition device 100, three images of different frequency ranges includes a far infrared light learning image, a near infrared light learning image and a visible light learning image on the template plane. The N characteristic points p_{A}¹, p_{A}² . . . , p_{A}^{N} of any one of the far infrared light learning image and the near infrared light learning image corresponds to the N characteristic points p_{B}¹, p_{B}² . . . , p_{B}^{N} of the visible light learning image in sequence. Then, the characteristic points or the intersecting points of the lines and the circles can be found using the projective geometry COOR(P_{B}ⁱ)=T×COOR(p_{A}ⁱ) (T is a transition function, COOR(p_{A}ⁱ) is a coordinate of a characteristic point of any one of the far infrared image and the near infrared image, COOR(pp) is a coordinate of a characteristic point of the visible light image) and thus the correlation between them can be found, such as one of the characteristic points of the visible light learning image correspond to which of the characteristic points of the near infrared learning image and which of the characteristic points of the far infrared learning image. Thereafter, obtaining a first transition function between the far infrared image and the visible light image and a second transition function that transfers the near infrared image to and the visible light image according to the correlation of the characteristic points. After obtaining the transition functions between different images, transition calculations can be performed between different types of images and produces an image fusion effect. As a result, the positions of the points of the far infrared image in the visible light image can be calculated, and fuse them with the visible light image. The positions of the points of the near infrared image in the visible light image can also be calculated, and fuse them with the visible light image. As a result, every pixel points of the visible light image has the characteristics of three frequencies, i.e. in a fused image, the image value of different frequencies (i.e. frequency range or wavelength range) can be stored in every pixel point to provide useful information for the image processing or pattern recognition thereafter. The transition functions described above can be saved in the memory electrically connects the image fusion processor 113 for the usage of the image fusion processor 113 of the thermal-imaging device 110, such that the composite image recognition device 100 with the thermal-imaging device 110 can be applied in the observing area A in actual use environment.

FIG. 2B is a flow chart of image processing of the image fusion processor 113 of FIG. 2A, according to the description above, the steps of the fusion of the first image and the second image of the thermal-imaging device 110 includes: in step S1, designing a template plane sensitive to far infrared light, near infrared light and visible light, on which are N characteristic points or intersecting straight lines or circles. In step S2, shooting a far infrared light learning image, a near infrared light learning image and a visible light learning image on the template plane. In step S3, finding a correlation between the N characteristic points or the intersection points of the straight lines or circles of the far infrared light learning image, the near infrared light learning image and the visible light learning image with an image processing algorithm of a projective geometry (i.e. COOR(P_{B}ⁱ)=T×COOR(p_{A}ⁱ)). Then in step S4, obtaining transition functions of different images according to the correlation of the characteristic points, such as a first transition function that transfers a coordinate of the far infrared image to a coordinate of a visible light image and a second transition function that transfers a coordinate of the near infrared image to a coordinate of a visible light image. In step S5, saving the coordinates of every pixel points of the visible light image with the characteristics of three frequencies (far infrared light, near infrared light and visible light) in the memory electrically connected to the image fusion processor 113. Thereafter in step S6, fusing the far infrared image and the visible light image according to the first transition function and the near infrared image and the visible light image according to the second transition function by the image fusion processor 113 of the thermal-imaging device 110 and producing an effect of image fusion.

Refer back to FIG. 1 and FIG. 2A, the adjustable light source module 130 is located in the thermal-imaging device 110, and includes a near infrared light source 132 and a light controller 134. The near infrared light source 132 electrically connects the light controller 134 to adjust the intensity of the near infrared light source 132 through the light controller 134. In some embodiments, the light controller 134 includes a knob 136 to let the user rotate to adjust the intensity of the near infrared light source 132. When the composite image recognition device 100 is used to observe a target in the area A, the adjustable light source module 130 can emit a near infrared light L by the near infrared light source 132 and irradiate the area A to improve the sharpness of the second image (such as the near infrared image). In other words, the adjustable light source module 130 provides the effect of auxiliary light source. As a result of such a design, the sharpness of the fused image of the thermal-imaging device 110 can be improved.

The low-light level night vision device 120 is adjacent to the thermal-imaging device 110, which can enhance the luminosity for several thousand times in a low visible light level environment. When the composite image recognition device 100 is used to observe a target in the area A, the glimmer light L3 (visible light) from the area A can be receive through the low-light level night vision device 120 and captures a brightened visible light image after enhancing the luminosity. As a result, an effect of clearly observing the object in the dark shadow of area A can be achieved through the fused image of the thermal-imaging device 110 and the brightened visible light image of the low-light level night vision device 120.

In particular, since the composite image recognition device 100 includes a thermal-imaging device 110, an adjustable light source module 130 and a low-light level night vision device 120, and the thermal-imaging device 110 includes a far infrared lens 112, a near infrared (NIR) lens 111 and an image fusion processor 113, such that when the composite image recognition device 100 observes an area A, the thermal-imaging device 110 can capture a far infrared image (i.e. the first image) and a near infrared/visible light image (i.e. the second image) of the area A. The low-light level night vision device 120 can capture a brightened visible light image of which luminous is enhanced of the area A, and the adjustable light source module 130 can adjust the brightness of the light according to the brightness of the area A. For example, if we want to see an object in the shadow of the area A, the luminosity of the near infrared light source 132 can be enhanced by the light controller 134; if the area is too bright and causes overexposure, the luminosity of the near infrared light source 132 can be reduced by the light controller 134. As a result of such a design, the sharpness of the near infrared light image can be greatly improved. After the image fusion processor 113 fuses the first image and the second image, a clear image of the object hiding in the shadow originally can be produced. The composite image recognition device 100 can be applied in night vision related apparatus of measurement, monitoring, medical care and military, is beneficial to the independent research and development of key component of military use and reduce the cost of purchasing oversea.

In the present embodiment, The far infrared lens 112 of the thermal-imaging device 110, the near infrared lens 111 of the thermal-imaging device 110, the visible light lens 122 of the low-light level night vision device 120 and the near infrared light source 132 of the adjustable light source module 130 is located at the front side of the case 150 and faces toward the direction D1. The far infrared lens 112, the near infrared lens 111 and the near infrared light source 132 can protrude out of the case 150, but not limited to it. They can also, for example, submerged into the front side of the case 150, as long as they expose through openings designed on the front side of the case 150. Furthermore, the low-light level night vision device 120 can be located on the top surface, the bottom surface or the front surface of the thermal-imaging device 110, but the disclosure is not limited to these.

The wavelength of the near infrared light source 132 of the adjustable light source module 130 is in a range of 920 nanometers to 960 nanometers. In this wavelength range, the near infrared light source 132 can provides a light beam (such as near infrared light L) to the area A that is invisible to human eye, but can be effectively detected by the near infrared lens 111 of the thermal-imaging device 110, such that the range of spectrum of the image (such as the near infrared image) captured by the thermal-imaging device 110 can be increased, which is beneficial to monitoring and military use, e.g. preventing the enemy in the dark environment to realized being detected and aimed.

The near infrared lens 111 of the thermal-imaging device 110 is configured to allow passage of a light L2 with a wavelength in a range of 0.4 micrometers to 1.0 micrometers. This wavelength range includes visible light (such as a wavelength of 400 nanometers to 800 nanometers) and near infrared light (such as a wavelength of 900 nanometers to 1000 nanometers) that is invisible to human eyes. The thermal-imaging device 110 captures the near infrared image/visible light image of the second image through the near infrared lens 111. The thermal-imaging device 100 further include an image sensor 115 and a digital circuit unit 117, the image sensor 115 faces toward the near infrared lens 111, the image sensor 115 and the near infrared lens 111 have no infrared cut filter in between, and the thermal-imaging device captures a visible light and a near infrared light through the image sensor. As a result of such a configuration, not only the cost is reduced, but also the image sensor 115 can receive a visible light and a near infrared light (such as the mixed light L2) reflected by the object when the near infrared light L of the near infrared light source 132 irradiate the area A. The digital circuit unit 117 electrically connects the image sensor 115 and the image fusion processor 113, the digital circuit unit 117 can convert the visible light and the near infrared light (i.e. light L2) received by the image sensor 115 into digital data for the image fusion processor 113 for image processing.

The far infrared lens 112 of the thermal-imaging device 110 allows the passage of the light L1 with a wavelength in a range of 8 micrometers to 14 micrometers. This range of wavelength is infrared light that is invisible to the human eye. The thermal-imaging device 110 captures the far infrared image of the first image by the far infrared lens 112. The thermal-imaging device 110 further includes a focal plane array 114 and a digital circuit unit 116. The focal plane array 114 faces toward the far infrared lens 112. When the far infrared lens 112 faces toward the area A, the focal plane array 114 can receive an infrared light (such as light L1) from the area A. The digital circuit unit 116 electrically connects the focal plane array 114 and the image fusion processor 113, the digital circuit unit 116 can convert the light L1 received by focal plane array 114 into digital data for the image fusion processor 113 for image processing.

In some embodiments, the digital circuit unit 116, 117 can be integrated circuit chips. The image processor can fuse the multi-spectrum image captured by the digital circuit unit 116, 117 through a Gaussian blur such that the far infrared thermal image of the first image and the near infrared/visible light image of the second image being fused into a high-resolution night vision image.

The composite image recognition device 100 further includes a head-mounted display 160. The head-mounted display 160 includes a first screen 162 and a second screen 164, the first screen 162 electrically connects the image fusion processor 113, the second screen 164 electrically connects the low-light level night vision device 120, such that the first screen 162 displays an image fused from the first image and the second image mentioned above, and the second screen 164 displays the brightened visible light image of the low-light level night vision device 120.

It is to be noted that the connection relationships, the materials, and the advantages of the elements described above will not be repeated in the following description. In the following description, other types of composite image recognition device are described.

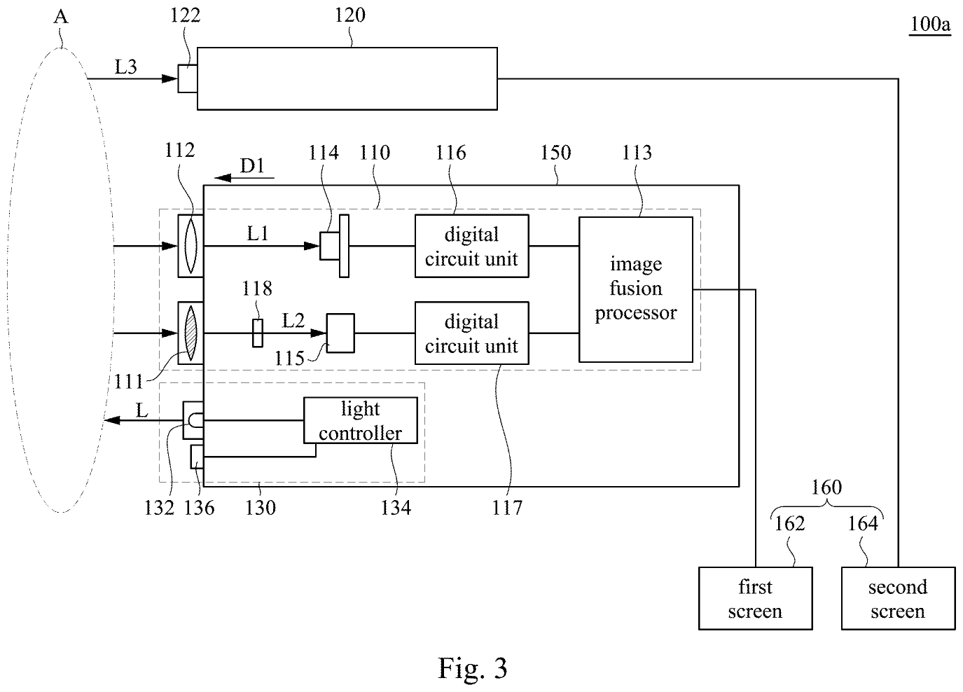

FIG. 3 is a schematic view of the composite image recognition device 100a when operating according to another embodiment of the present disclosure. Refer to FIG. 3, a composite image recognition device 100a includes a thermal-imaging device 110, an adjustable light source module 130 and a low-light level night vision device 120. The difference between the present embodiment and the embodiment of FIG. 2A is that the thermal-imaging device 110 of the composite image recognition device 100a further includes an infrared pass filter 118. The infrared pass filter 118 is located between the near infrared lens 111 and the image sensor 115. The infrared pass filter 118 allows the passage of the near infrared light (light L2) and the transmission to the image sensor 115.

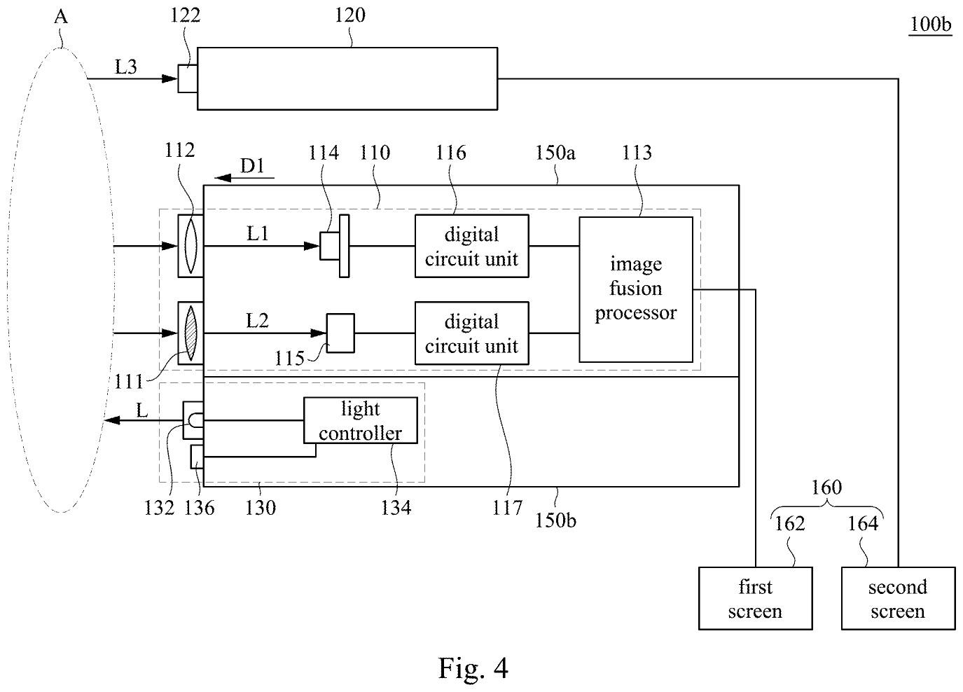

FIG. 4 is a schematic view of the composite image recognition device 100b when operating according to yet another embodiment of the present disclosure. Refer to FIG. 4, a composite image recognition device 100b includes a thermal-imaging device 110, an adjustable light source module 130 and a low-light level night vision device 120. The difference between the present embodiment and the embodiment of FIG. 2A is that the composite image recognition device 100b includes two cases 150a, 150b, in which the case 150a accommodates the thermal-imaging device 110, and the case 150b accommodates the adjustable light source module 130. Hereby, the adjustable light source module 130 is coupled with the thermal-imaging device 110 and is detachable, such as coupled with latches. As a result, the thermal-imaging device 110 and the adjustable light source module 130 can be decided by the user whether being detached or attached, which is beneficial to storage and carrying.

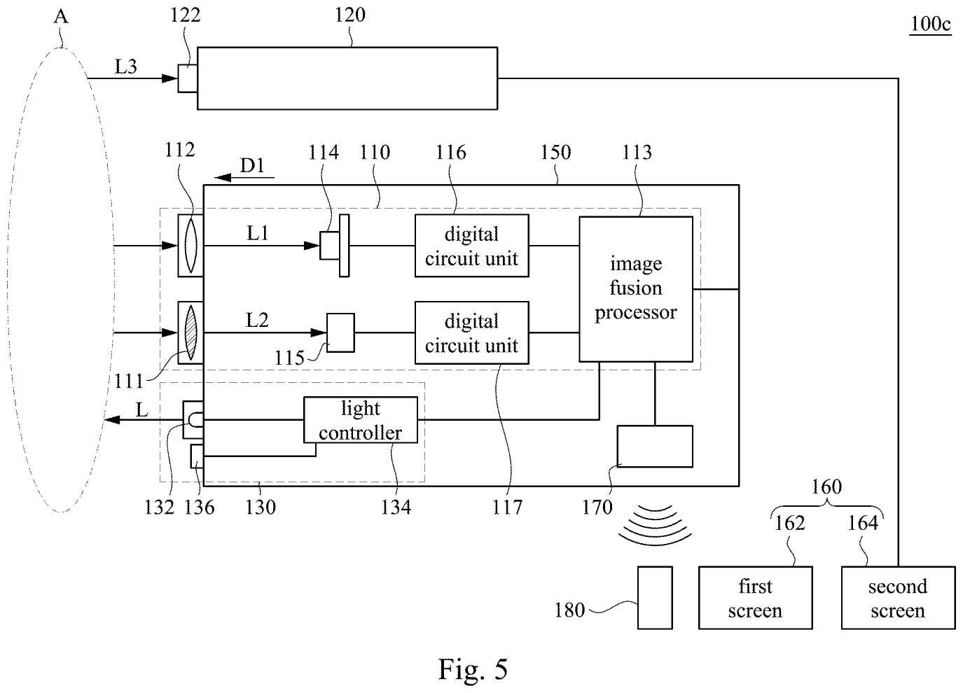

FIG. 5 is a schematic view of the composite image recognition device 100c when operating according to yet another embodiment of the present disclosure. Refer to FIG. 4, a composite image recognition device 100c includes a thermal-imaging device 110, an adjustable light source module 130 and a low-light level night vision device 120. The difference between the present embodiment and the embodiment of FIG. 2A is that the light controller 134 of the adjustable light source module 130 of the composite image recognition device 100c electrically connects the image fusion processor 113, and the composite image recognition device 100c further includes a wireless transmission module 170 and a wireless receiving module 180. Since the light controller 134 electrically connects the image fusion processor 113, when the image fusion processor 113 determines that the fused image is too dark or too bright (i.e. overexpose), the image fusion processor 113 can sends a brightening signal or a darkening signal to the light controller 134, such that the near infrared light source 132 adjusts an intensity automatically to produce an appropriate intensity of the near infrared light L to irradiate the observing area A.

Furthermore, the wireless transmission module 170 electrically connects the image fusion processor 113. The wireless receiving module 180 electrically connects the first screen 162 of the head-mounted display 160 and wirelessly connects to the wireless transmission module 170, such that the first screen 162 of the head-mounted display 160 can display the image fused by the image fusion processor 113. In the present embodiment, the wirelessly connection includes Wi-Fi connection, but the disclosure is not limited to this.

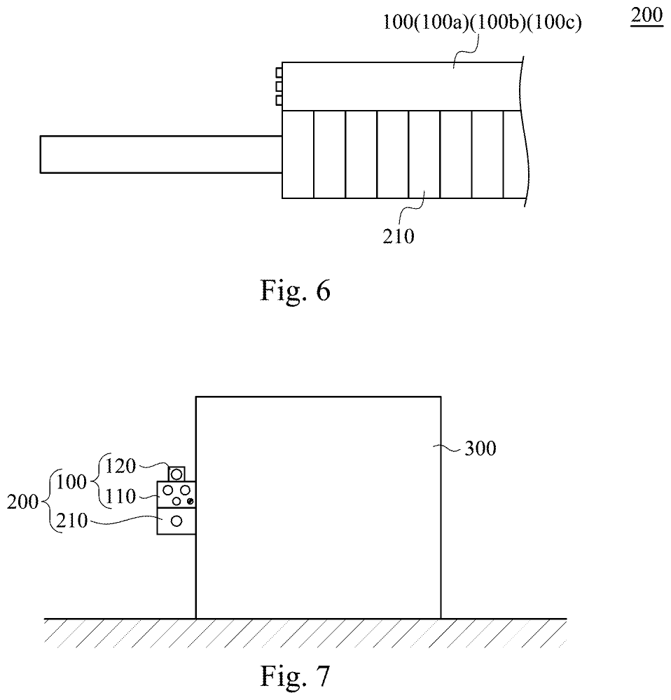

FIG. 6 is a side view of a military equipment 200 according to some embodiment of the present disclosure. Refer to FIG. 2A and FIG. 6, the military equipment 200 includes a shooting apparatus 210 and the composite image recognition device 100 mentioned above. The composite image recognition device 100 is located on the shooting apparatus 210. The shooting apparatus 210 can be, for example, a variety of artilleries or guns. When using, an observation and aiming can be performed to the target in the area A using the composite image recognition device 100, such that the head-mounted display 160 can display the image fused by the image fusion processor 113, afterwards, shoot the target with the shooting apparatus 210. The light receiving and image fusing mechanism of the composite image recognition device 100 are as mentioned above, so it will not be repeated.

Furthermore, it is to be noted that the composite image recognition devices 100a, 100b and 100c of FIG. 3 to FIG. 5 can also be applied to the military equipment 200 to replace the composite image recognition device 100. In the following description, it is to be noted that only the military equipment 200 with the composite image recognition device 100 of FIG. 6 will be described as an example.

FIG. 7 is a schematic view of the military equipment of FIG. 6 when using. Refer to FIG. 2A and FIG. 7, the composite image recognition device 100 and the shooting apparatus 210 of the military equipment 200 can protrude out of the shelter 300. In the present embodiment, the shelter 300 can be, for example, a wall body. The user can hide behind the shelter 300, observe/aim at the target in the area A by the composite image recognition device 100 and the head-mounted display 160 of the composite image recognition device 100 and shoot the target with the shooting apparatus 210. Furthermore, in another embodiment, the shooting apparatus 210 can be triggered with a remote controller (such as a remote controlled machine gun). The user can observe/aim at the target in the area A by the head-mounted display 160 and press the remote controller of the shooting apparatus 210 to shoot the target.

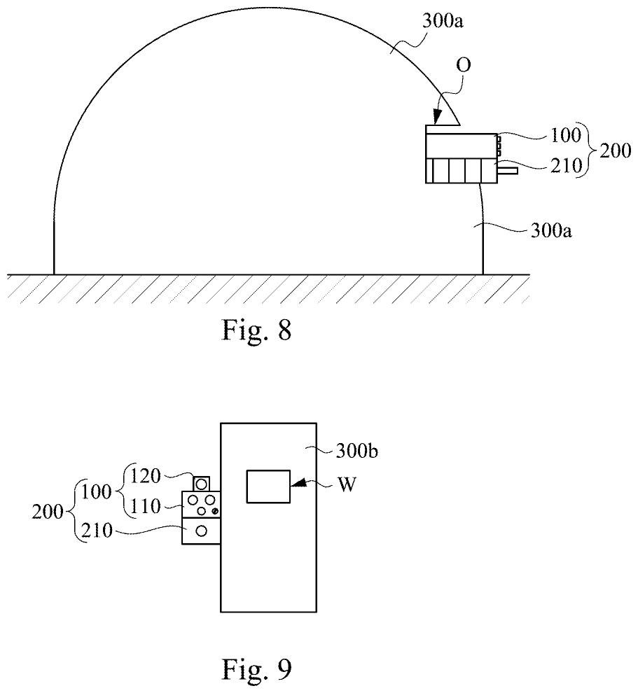

FIG. 8 is a schematic view of the military equipment of FIG. 6 when using. Refer to FIG. 2A and FIG. 8, the composite image recognition device 100 and the shooting apparatus 210 of the military equipment 200 can protrude out of the opening O of the shelter 300a. In the present embodiment, the shelter 300a can be, for example, a pillbox. The user can hide in the shelter 300a, observe/aim at the target in the area A by the composite image recognition device 100 and the head-mounted display 160 of the composite image recognition device 100 and shoot the target with the shooting apparatus 210.

FIG. 9 is a schematic view of the military equipment of FIG. 6 when using. Refer to FIG. 2A and FIG. 9, the composite image recognition device 100 and the shooting apparatus 210 of the military equipment 200 can protrude out of the shelter 300b. In the present embodiment, the shelter 300 can be, for example, a shield, and can have a window W. The user can hide behind the shelter 300b, observe/aim at the target in the area A by the composite image recognition device 100 and the head-mounted display 160 of the composite image recognition device 100 and shoot the target with the shooting apparatus 210.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A composite image recognition device, comprising:
a thermal-imaging device comprising a far infrared lens, a near infrared lens and an image fusion processor, wherein the thermal-imaging device captures a first image of an area by a light that is allowed to pass through the far infrared lens and captures a second image of the area by a light that is allowed to pass through the near infrared lens, the first image is a far infrared image, the second image comprises a near infrared image and a visible light image, wherein the image fusion processor obtains a first transition function that transfers a coordinate of the far infrared image to a coordinate of the visible light image and a second transition function that transfers a coordinate of the near infrared image to a coordinate of the visible light image respectively according to the following projective geometry:
$$COOR ( {p}_{B}^{i} ) = T \times COOR ( {p}_{A}^{i} )$$
wherein T is a transition function, COOR(p_{A}ⁱ) is a coordinate of a characteristic point of any one of the far infrared image and the near infrared image, and COOR(p_{B}ⁱ) is a coordinate of a characteristic point of the visible light image, wherein the image fusion processor fuses the far infrared image and the visible light image according to the first transition function and fuses the near infrared image and the visible light image according to the second transition function;
an adjustable light source module located in the thermal-imaging device, comprising a near infrared light source and a light controller electrically connected to each other, and irradiating the area through a near infrared light emitted by the near infrared light source; and
a low-light level night vision device adjacent to the thermal-imaging device and capturing a brightened visible light image through the low-light level night vision device.

2. The composite image recognition device of claim 1, wherein the thermal-imaging device comprises an image sensor, the image sensor faces toward the near infrared lens, the image sensor and the near infrared lens have no infrared cut filter in between, and the thermal-imaging device captures a visible light and a near infrared light through the image sensor.

3. The composite image recognition device of claim 2, wherein the thermal-imaging device has a digital circuit unit, wherein the digital circuit unit electrically connects the image sensor and the image fusion processor.

4. The composite image recognition device of claim 1, wherein the thermal-imaging device has a digital circuit unit, wherein the digital circuit unit electrically connects a focal plane array and the image fusion processor and transfers an infrared light received by the focal plane array to a digital data for the image fusion processor to process an image.

5. The composite image recognition device of claim 1, wherein the light controller electrically connects the image fusion processor, and the image fusion processor hereby sends a brightening signal or a darkening signal to the light controller, such that the near infrared light source adjusts an intensity automatically.

6. The composite image recognition device of claim 1, wherein a wavelength of the near infrared light source of the adjustable light source module is in a range of 920 nanometers to 960 nanometers, and hereby provide an invisible light to the area and improving a sharpness of the second image of the thermal-imaging device.

7. The composite image recognition device of claim 1, wherein the near infrared lens of the thermal-imaging device is configured to allow passage of a light with a wavelength in a range of 0.4 micrometers to 1.0 micrometers, and hereby captures the near infrared image and the visible light image of the second image.

8. The composite image recognition device of claim 1, further comprising:
a head-mounted display comprising a first screen and a second screen, wherein the first screen electrically connects the image fusion processor, the second screen electrically connects the low-light level night vision device, hereby, the first screen displays an image fused from the first image and the second image, and the second screen displays the brightened visible light image of the low-light level night vision device.

9. The composite image recognition device of claim 8, further comprising:
a wireless transmission module electrically connected the image fusion processor; and
a wireless receiving module electrically connected the head-mounted display and wirelessly connected to the wireless transmission module, hereby, the image fused from the first image and the second image is wirelessly transmitted to the first screen of the head-mounted display.

10. The composite image recognition device of claim 1, wherein the image fusion processor shoots a far infrared light learning image, a near infrared light learning image and a visible light learning image on a template plane with N characteristic points, or intersecting straight lines or circles that is sensitive to far infrared light, near infrared light and visible light through the thermal-imaging device, wherein the N characteristic points p_{A}¹, p_{A}² . . . , p_{A}^{N} of any one of the far infrared light learning image and near infrared light learning image correspond to the N characteristic points p_{B}¹, p_{B}² . . . , p_{B}^{N} of the visible light learning image in sequence, and thus the first transition function and the second transition function are obtained by using projective geometry COOR(p_{B}ⁱ)=T×COOR(p_{A}ⁱ), hereby, the image fusion processor fuses the first image and the second image.

11. A composite image recognition device, comprising:
a thermal-imaging device comprising a far infrared lens, a near infrared (NIR) lens, an image sensor and an image fusion processor, wherein the thermal-imaging device captures a first image of an area by a light that is allowed to pass through the far infrared lens, and captures a second image of the area by a light that is allowed to pass through the near infrared lens, wherein the first image is a far infrared image, and the second image comprises a near infrared image and a visible light image, wherein the image fusion processor obtains a first transition function that transfers a coordinate of the far infrared image to a coordinate of the visible light image and a second transition function that transfers a coordinate of the near infrared image to a coordinate of the visible light image respectively according to the following projective geometry:
$$COOR ( {p}_{B}^{i} ) = T \times COOR ( {p}_{A}^{i} )$$
wherein T is a transition function, COOR(p_{A}ⁱ) is a coordinate of a characteristic point of any one of the far infrared image and the near infrared image, and COOR(p_{B}ⁱ) is a coordinate of a characteristic point of the visible light image, wherein the image fusion processor fuses the far infrared image and the visible light image according to the first transition function, and fuses the near infrared image and the visible light image according to the second transition function, wherein the image sensor faces toward the near infrared lens;
an adjustable light source module located in the thermal-imaging device, comprising a near infrared light source and irradiating the area through a near infrared light emitted by the near infrared light source; and
a low-light level night vision device adjacent to the thermal-imaging device and capturing a brightened visible light image through the low-light level night vision device.

12. The composite image recognition device of claim 11, wherein the thermal-imaging device further comprising:
an infrared pass filter located between the near infrared lens and the image sensor, and hereby allows passage of a near infrared light and detection by the image sensor.

13. The composite image recognition device of claim 11, wherein the thermal-imaging device further comprises a focal plane array, the focal plane array faces toward the far infrared lens and hereby receives an infrared light from the area.

14. The composite image recognition device of claim 11, further comprising:
at least one case accommodating the thermal-imaging device and the adjustable light source module, hereby, the far infrared lens and the near infrared lens of the thermal-imaging device and the near infrared light source of the adjustable light source module are located at a front side of the case and face toward the same direction.

15. The composite image recognition device of claim 11, wherein the far infrared lens of the thermal-imaging device is configured to allow passage of a light with a wavelength in a range from 8 micrometers to 14 micrometers, and hereby captures the far infrared image of the first image.
